(19) United States
(12) Patent Application Publication
(10) Pub. No.: US 2025/0388146 A1
(43) Pub. Date: Dec. 25, 2025

(54) BACK FRAME

(71) Applicant: TOYOTA BOSHOKU KABUSHIKI KAISHA, Aichi (JP)

(72) Inventors: Yushi SHINOZAKI, Toyota-shi (JP); Yuya AKAI, Miyoshi-shi (JP)

(73) Assignee: TOYOTA BOSHOKU KABUSHIKI KAISHA, Aichi (JP)

(21) Appl. No.: 19/240,572

(22) Filed: Jun. 17, 2025

(30) Foreign Application Priority Data
Jun. 21, 2024 (JP) 2024-100260

(51) Int. Cl. B60N 2/68

(52) U.S. Cl. CPC B60N 2/682

(57) ABSTRACT

To provide a back frame of a vehicle seat. A back frame of the present disclosure includes a first side frame and a second side frame, an upper frame and a lower frame, a first flange portion provided in the lower frame, a first flat surface portion provided in the lower frame, a second flange portion provided in the first side frame and having a second flat surface portion, and a third flat surface portion provided in the lower frame. At least one of the second flat surface portion and the third flat surface portion protrudes toward the other flat surface portion, and a welding mark is present on an intermediate portion in a seat width direction of the one flat surface portion.

### CROSS-REFERENCE TO RELATED APPLICATIONS

The present application claims priority based on Japanese Patent Application No. 2024-100260 filed to Japanese Patent Office on Jun. 21, 2024, and the content of Japanese Patent Application No. 2024-100260 is incorporated by reference in its entirety.

### BACKGROUND

The present disclosure relates to a back frame of a vehicle seat.

For example, in the back frame described in Japanese Unexamined Patent Application Publication No. 2022-167380, two side frames, an upper frame, a lower frame, and the like constitute a frame-shaped frame. The frames are welded to each other.

### SUMMARY

The present disclosure discloses an example of a back frame capable of reducing welding defects between a side frame and a lower frame.

A back frame of a vehicle seat desirably includes, for example, at least one of the following components.

The components include a first side frame extending in a vertical direction, a second side frame disposed at a position shifted from the first side frame in a seat width direction, the second side frame extending in the vertical direction, an upper frame extending in the seat width direction and connecting an upper end side of the first side frame and an upper end side of the second side frame, a lower frame extending in the seat width direction and connecting a lower end side of the first side frame and a lower end side of the second side frame, a first flange portion provided at an upper end edge of the lower frame and extending from the upper end edge in a seat longitudinal direction, a first flat surface portion provided on one end side in an extending direction of the lower frame, the first flat surface portion being provided at a position shifted from one end in the seat width direction of the first flange portion toward the first side frame, a second flange portion provided on a rear end side of the first side frame and extending toward the second side frame, the second flange portion including a second flat surface portion continuous with an opposing surface opposing the first flat surface portion, and a third flat surface portion provided on one end side in the extending direction of the lower frame, the third flat surface portion partially including the first flat surface portion and opposing the second flat surface portion.

It is desirable that at least one of the second flat surface portion and the third flat surface portion protrudes toward the other flat surface portion, and a welding mark is present on an intermediate portion in the seat width direction of the one flat surface portion.

As a result, in the back frame, it is possible to pinch (hereinafter, also referred to as “clamp”) the lower frame and the first side frame using the first flat surface portion.

In addition, since the welding mark is on the intermediate portion in the seat width direction of the one flat surface portion, a welding operator (also including an automatic welding machine) can perform welding in a state where both one side and the other side are clamped with the welding mark interposed therebetween.

As described above, since the welding operator can perform welding in a state where the first side frame and the lower frame are clamped at the planar portions, it is possible to reduce welding defects between the side frame and the lower frame in the back frame.

The third flat surface portion desirably protrudes toward the second flat surface portion. In addition, the first flange portion may be eliminated, or the joint portion of the second side frame and the lower frame may have the same configuration of the joint portion of the first side frame and the lower frame.

### BRIEF DESCRIPTION OF THE DRAWINGS

An example embodiment of the present disclosure will be described below with reference to the accompanying drawings, in which:

FIG. 1 is a diagram illustrating a back frame;

FIG. 2 is a diagram illustrating a joint portion;

FIG. 3 is a diagram illustrating a lower frame; and

FIG. 4 is an exploded diagram of the joint portion.

### DETAILED DESCRIPTION OF EXEMPLARY EMBODIMENTS

The following “embodiments of the present invention” illustrate examples of embodiments falling within the technical scope of the present disclosure. That is, the matters specifying the invention and the like described in the claims are not limited to the specific configurations, structures and the like described in the following embodiments.

The present embodiment is an example of a back frame of a seat (hereinafter, referred to as vehicle seat) mounted on a vehicle such as an automobile. Arrows indicating directions, oblique lines, and the like attached to the individual drawings are described in order to facilitate understanding of the relationship between the individual drawings, the shape of members or portions, and the like.

The back frame is not limited to the directions illustrated in the drawings. The directions illustrated in the individual drawings are directions in a state where the vehicle seat is assembled to a vehicle. The view with oblique lines does not necessarily show a cross-sectional view.

At least one member or portion described with at least a reference sign is provided unless otherwise noted such as “only one”. That is, when there is no description such as “only one”, two or more members may be provided. The back frame disclosed in the present disclosure includes at least one of components such as members or portions described with at least reference signs and structural portions shown in the drawings.

### First Embodiment

### <1. Outline of Back Frame>

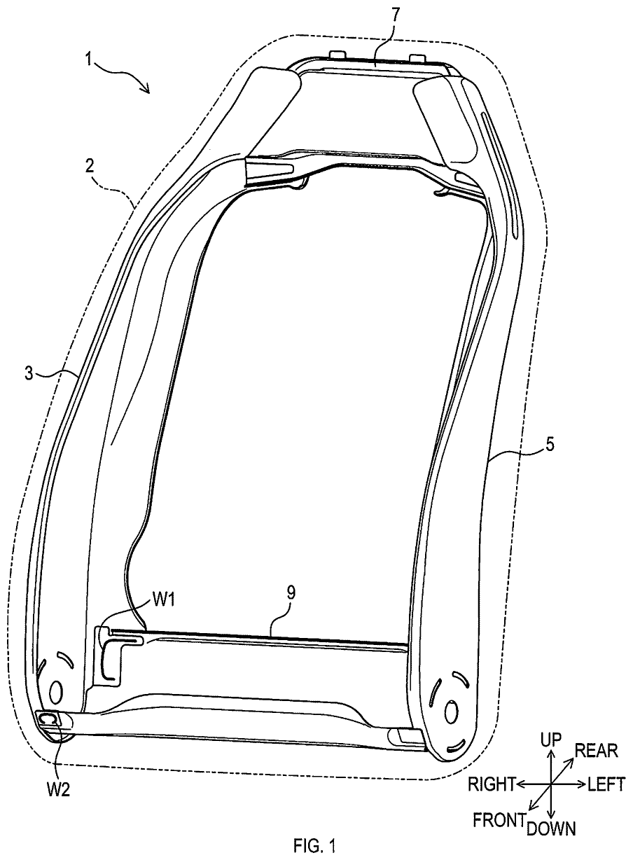

As illustrated in FIG. 1, a back frame 1 is a substantially rectangular frame-shaped frame constituting the framework of a seat back 2. The seat back 2 is a portion for supporting the back of a sitter.

The back frame 1 includes a first side frame 3, a second side frame 5, an upper frame 7, and a lower frame 9. The first side frame 3 and the second side frame 5 are strength members extending substantially in the vertical direction.

The second side frame 5 is disposed at a position shifted from the first side frame 3 in a seat width direction (in FIG. 1, to the left side). The upper frame 7 is a strength member extending in the seat width direction and connecting the upper end side of the first side frame 3 and the upper end side of the second side frame 5.

The lower frame 9 is a strength member extending in the seat width direction and connecting the lower end side of the first side frame 3 and the lower end side of the second side frame 5. The first side frame 3, the second side frame 5, the upper frame 7, and the lower frame 9 are made of metal, and the frames are joined by laser welding.

### <2. Configuration of Joint Portion of Side Frame and Lower Frame>

The configuration of the joint portion of the first side frame 3 and the lower frame 9 is the same as the configuration of the joint portion of the second side frame 5 and the lower frame 9. These two configurations are substantially line-symmetric with respect to a virtual line crossing the center in the extending direction of the lower frame 9.

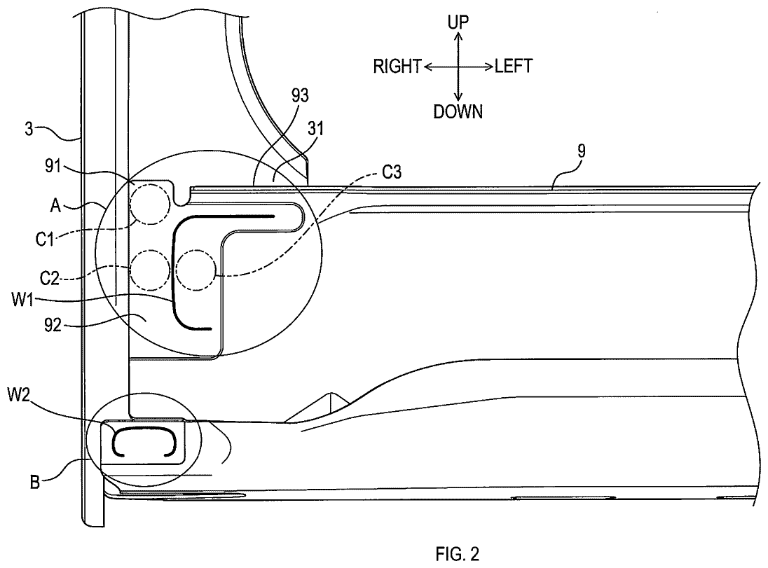

The following description relates to the configuration of the joint portion (in particular, part A in FIG. 2) of the first side frame 3 and the lower frame 9.

As illustrated in FIG. 2, the first side frame 3 and the lower frame 9 are joined to each other at least at the part A and a part B. A thick solid line W1 illustrated in the part A and a thick solid line W2 illustrated in the part B indicate welding marks by laser welding.

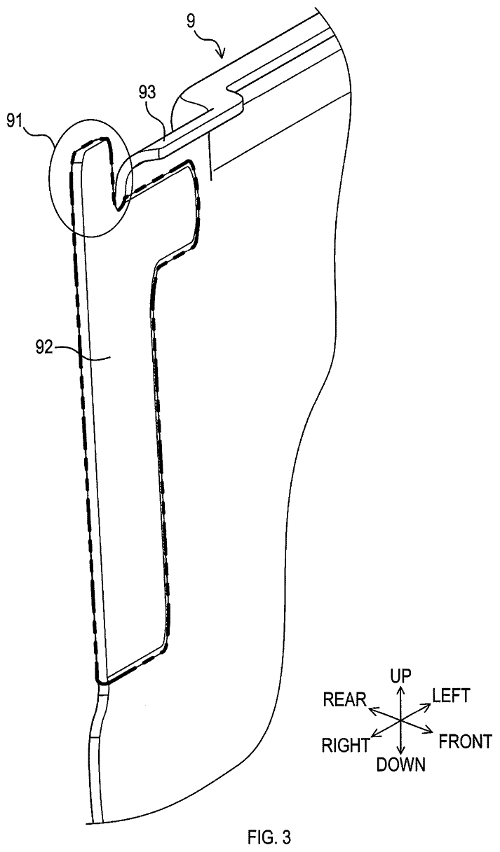

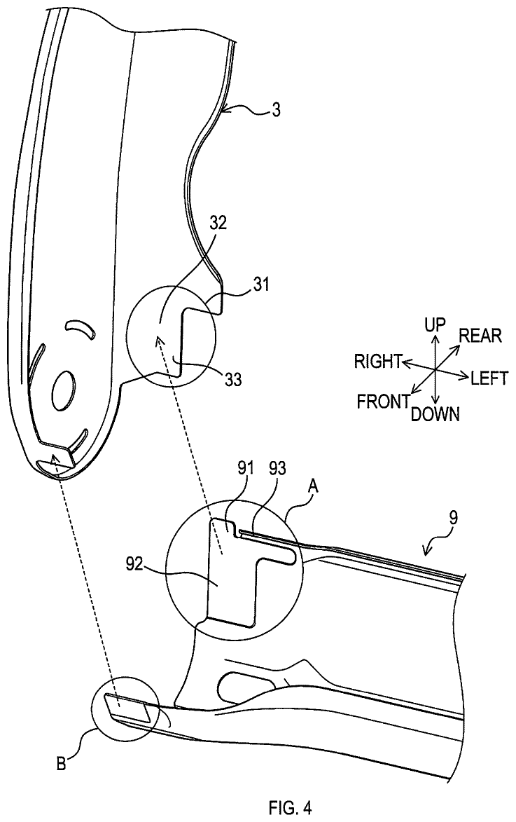

As illustrated in FIG. 3, the lower frame 9 includes a first flat surface portion 91, a third flat surface portion 92, and a first flange portion 93. As illustrated in FIG. 4, the first side frame 3 includes a second flange portion 31.

As illustrated in FIG. 3, the first flange portion 93 is a portion provided at the upper end edge of the lower frame 9 and extending from the upper end edge in a seat longitudinal direction (in the present embodiment, to the front side). The first flat surface portion 91 is a flat surface portion provided on one end side in the extending direction of the lower frame 9.

The first flat surface portion 91 is provided at a position shifted from one end in the seat width direction of the first flange portion 93 toward the first side frame 3. Specifically, the first flat surface portion 91 is provided on the right end side of the lower frame 9 and at a position shifted further to the right side than the right end of the first flange portion 93.

As illustrated in FIG. 4, the second flange portion 31 is a planar portion provided at the rear end of the first side frame 3 and extending toward the second side frame 5. The second flange portion 31 has a second flat surface portion 33 continuous with an opposing surface 32 opposing the first flat surface portion 91.

The third flat surface portion 92 is a flat surface portion provided on one end (in FIG. 4, the right end) side in the extending direction of the lower frame 9. The third flat surface portion 92 (range surrounded by a thick two-dot chain line in FIG. 3) is a flat surface portion partially including the first flat surface portion 91 and opposing the second flat surface portion 33.

At least one of the second flat surface portion 33 and the third flat surface portion 92 protrudes toward the other flat surface portion. Specifically, the third flat surface portion 92 protrudes toward the second flat surface portion 33.

The first flat surface portion 91, the third flat surface portion 92, and the first flange portion 93 are integrally molded together with the lower frame 9 by applying plastic working such as press working to a steel plate. Similarly, the opposing surface 32, the second flat surface portion 33, and the second flange portion 31 are integrally molded together with the first side frame 3 by applying plastic working such as press working to a steel plate.

As illustrated in FIG. 2, the welding mark indicated by the thick solid line W1 is present on the intermediate portion in the seat width direction of the third flat surface portion 92. That is, a welding operator (including an automatic welding machine) irradiates the intermediate portion in the seat width direction of the third flat surface portion 92 with a welding laser beam.

### <3. Characteristics of Back Frame>

In the back frame 1, the third flat surface portion 92 protrudes toward the second flat surface portion 33, and the welding mark (thick solid line W1) of laser welding is present on the intermediate portion in the seat width direction of the third flat surface portion 92.

As a result, in the back frame 1, it is possible to pinch (hereinafter, also referred to as “clamp”) the lower frame 9 and the first side frame 3 using the first flat surface portion 91.

Specifically, laser welding is performed in a state where portions C to C3 indicated by two-dot chain lines in FIG. 2 are clamped. That is, at the time of welding, the welding operator can clamp both one side and the other side with the welding mark W1 interposed therebetween.

As described above, since the welding operator can perform welding in a state where the first side frame 3 and the lower frame 9 are clamped at the planar portions, it is possible to reduce welding defects between the side frame and the lower frame in the back frame 1.

### Other Embodiments

In the embodiment described above, the third flat surface portion 92 protrudes toward the second flat surface portion 33. However, the present disclosure is not limited thereto. For example, the third flat surface portion 92 and the second flat surface portion 33 may protrude toward each other, or the second flat surface portion 33 may protrude toward the third flat surface portion 92.

In the embodiment described above, the first side frame 3 and the lower frame 9 are joined by laser welding. However, the present disclosure is not limited thereto. For example, the first side frame 3 and the lower frame 9 may be joined with an adhesive.

In the embodiment described above, the lower frame 9 includes the first flange portion 93. However, the present disclosure is not limited thereto. For example, the first flange portion 93 may be eliminated.

In the embodiment described above, the vehicle seat according to the present disclosure is applied to a vehicle. However, the application of the invention disclosed herein is not limited thereto. For example, the present invention can also be applied to seats used for vehicles such as railway vehicles, ships, and aircrafts, and stationary seats used in theaters, homes, and the like.

Furthermore, the present disclosure is not limited to the embodiments described above as long as it meets the gist of the disclosure described in the embodiments. Therefore, a configuration in which at least two of the plurality of embodiments described above are combined, or a configuration in which any of the components illustrated in the drawings or the components described with reference signs in the embodiments is eliminated may be used.

What is claimed is:

1. A back frame of a vehicle seat, comprising:
a first side frame extending in a vertical direction;
a second side frame disposed at a position shifted from the first side frame in a seat width direction, the second side frame extending in the vertical direction;
an upper frame extending in the seat width direction and connecting an upper end side of the first side frame and an upper end side of the second side frame;
a lower frame extending in the seat width direction and connecting a lower end side of the first side frame and a lower end side of the second side frame;
a first flange portion provided at an upper end edge of the lower frame and extending from the upper end edge in a seat longitudinal direction;
a first flat surface portion provided on one end side in an extending direction of the lower frame, the first flat surface portion being provided at a position shifted from one end in the seat width direction of the first flange portion toward the first side frame;
a second flange portion provided on a rear end side of the first side frame and extending toward the second side frame, the second flange portion including a second flat surface portion continuous with an opposing surface opposing the first flat surface portion; and
a third flat surface portion provided on one end side in the extending direction of the lower frame, the third flat surface portion partially including the first flat surface portion and opposing the second flat surface portion, wherein
at least one of the second flat surface portion and the third flat surface portion protrudes toward the other flat surface portion, and
a welding mark is present on an intermediate portion in the seat width direction of the one flat surface portion.

2. A back frame of a vehicle seat, comprising:
a first side frame extending in a vertical direction;
a second side frame disposed at a position shifted from the first side frame in a seat width direction, the second side frame extending in the vertical direction;
an upper frame extending in the seat width direction and connecting an upper end side of the first side frame and an upper end side of the second side frame;
a lower frame extending in the seat width direction and connecting a lower end side of the first side frame and a lower end side of the second side frame;
a first flat surface portion provided on one end side in an extending direction of the lower frame;
a flange portion provided on a rear end side of the first side frame and extending toward the second side frame, the flange portion including a second flat surface portion continuous with an opposing surface opposing the first flat surface portion; and
a third flat surface portion provided on one end side in the extending direction of the lower frame, the third flat surface portion partially including the first flat surface portion and opposing the second flat surface portion, wherein
at least one of the second flat surface portion and the third flat surface portion protrudes toward the other flat surface portion, and
a welding mark is present on an intermediate portion in the seat width direction of the one flat surface portion.

3. The back frame according to claim 1, wherein the third flat surface portion protrudes toward the second flat surface portion.
